(19) United States
(12) Patent Application Publication
(10) Pub. No.: US 2026/0361548 A1
(43) Pub. Date: Nov. 12, 2026

(54) BLOCKCHAIN-BASED SYSTEM FOR SECURE DOCUMENT PROVENANCE, RECORDING, AND AUTHENTICATION

(71) Applicants: Michael Nicholas POCALYKO, Reston, VA (US); Mark David YOUNG, Ellicott City, MD (US)

(72) Inventors: Michael Nicholas POCALYKO, Reston, VA (US); Mark David YOUNG, Ellicott City, MD (US)

(21) Appl. No.: 19/672,003

(22) Filed: May 8, 2026

Related U.S. Application Data
(60) Provisional application No. 63/802,923, filed on May 9, 2025.

(51) Int. Cl. H04L 9/32; H04L 9/00

(52) U.S. Cl. CPC H04L 9/3236; H04L 9/50

(57) ABSTRACT

In digital commerce, law, and intelligence, the ability to verify provenance, authenticity, integrity, and edit history of documents—anything rendered digitally—is paramount. From ensuring validity of contracts to protecting intellectual property to securing classified documents, the need for robust document provenance mechanisms is more critical than ever. Conventional document management systems rely on centralized databases susceptible to tampering, single points of failure, and lack of transparency. Blockchain technology enables user-controlled registration of documents, substantiation of documents by public key cryptography, and registration by a hash value on blockchain. A document is registered without content, origin information, or its substance being exposed. In response to and acceptance of an authentication demand, a parallel zero-trust decryption reversing process enables the owner-controller of a document to prove the hash and tie it to the document. The system provides enhanced security, immutability, and zero-trust traceability of document origin, date-time existence, etiology, and history.

### CROSS-REFERENCE TO RELATED APPLICATIONS

This application is based on and claims priority to provisional application 63/802,923 filed on May 9, 2025. The entire content of the priority application is incorporated herein by reference.

### BACKGROUND OF THE INVENTION

The present invention relates to a system that addresses critical shortcomings that are present in every business and government domain where document creation, storage, retrieval, and management are required. In the present disclosure of the invention, the term “document” can take numerous forms. The word “document” as used in this disclosure is delimited and refers to anything physical or digital that is able to be rendered or re-rendered in a digital form, including but not limited to documents, items, artifacts, and three-dimensional objects that are initially physical in form; digital documents that are created from paper or other two-dimensional original form; two-dimensional or three-dimensional images; audio or video files rendered digitally; lines of code; or documents that are organically conceptualized and created as digital content or modified into digital content; with forms including any type of digital object or file or any part thereof.

Examples of “documents” may include, but are not limited to, word-processed documents, portable document format (PDF) documents, e-mails, e-mail headers, digital texts, digital texts with graphic or photographic elements, digital photographic images, scans, wet-signature executed signed contracts, laser printed or handwritten pages, legacy faxes, archival photographic prints, archival paper documents, web page extracts or whole web pages, screen captures, federal and state forms (e.g., tax returns, regulatory filings), online education assignments, lines of code, blocks of code, compiled programs, law enforcement sensitive or court-sealed files, and U.S. Department of Defense and Intelligence Community classified documents.

The current state of technology in document provenance verification is still principally manual, performed by human operators on computer workstations. Automated systems, machine-learning indices, and artificial intelligence are all beginning to be applied to a broad, deep, diffuse, non-integrated collection of databases and new data storage methodologies. Some of these storage facilities are cloud-based, some are in local networks, and some are physical media. This disclosure proactively anticipates its application, without limitation, to these emerging technologies (those embodying artificial intelligence implementations in particular), and these advanced technology storage methodologies and facilities.

These technologies, even in their emerging and cutting-edge variants, still suffer from the shortcomings of current solutions. There exist severe limitations in traditional information technology storage methods and in centralized databases. They suffer from a lack of transparency, vulnerability to intrusion, hacking, and tampering, and represent single points of failure for any individual or organization.

Shortcomings in traditional document management can be summarized in several critical areas:
Physical and digital barriers: Original physical documents exist in a specific location. Copies of this original document may exist other places, but these physical copies are not current with any changes made to the original. From the moment a copy is made, it represents an opportunity for manipulation and potentially fraudulent claims of origin authenticity. Access or changes to an original physical document are not tracked or transferred to any copies of the original document. Variance between and among the original document and copies thereof may be limited only by a number of copies made or changes to the original document. Digital documents stored either on an individual device or in cloud servers are also not updated concurrently with the original document. Moreover, digital documents may be more susceptible to modification and unauthorized manipulation because of the nature of digital objects.
Remote work challenges: Employees working remotely may have difficulty accessing physical documents or files stored on local servers; security remains a trade-off for access and authenticity of original documents may be diminished with each change effected remotely. Web-based shared documents and spreadsheets do facilitate near-real-time document updates by multiple individuals. These services (e.g., Google Docs, Google Sheets) provide an opportunity for various authenticity compromises, such as user account compromise, malware exploitations, and social engineering attacks.
Real-time access issues: Sharing or collaborating on document creation or editing may require passing versions back and forth or physically transporting papers; authenticity degrades with each ensuing version and through revisions, edits, and changes in document type as applied to existing revised versions.
Poor version control: Version confusion is created when multiple copies of the same original document exist with slight differences, leading to errors and inefficiencies where no user-controlled registry is maintained. Version control is a particularly acute problem in litigation discovery, with large volumes of discovery material having potential differences between similar files.
Overwrites and loss: Absent a secure, robust, permanent, and immutable version tracking system subject to zero-trust third-party verification and authentication, critical updates are overwritten or lost.
Unauthorized access: Without granular recorded permissions, sensitive or classified documents are accessible to more people than necessary.
Poor audit readiness: There is inherent difficulty in finding and producing documents quickly for financial audits or legal inquiries.
Regulatory non-compliance: Industries and sectors with strict regulatory requirements (e.g., healthcare, finance) require traceability, secure storage, and specific retention periods—which traditional systems most often fail reliably to enforce.

Blockchain technology offers a promising alternative by providing a decentralized and immutable ledger for recording and verifying information about secure registered documents.

Examples of instances where document provenance verification may be applicable include the following examples: (1) A sealed document produced by a U.S. Attorney prosecuting a sensitive criminal matter in federal court, where the name and identifying details of confidential informants are contained, and where defense counsel must be made knowledgeable of the existence of the relevant information, but where the court has ruled that its specific content and the origin of the relevant information may not be revealed; (2) An analytical document produced by an expert witness for a litigant in a civil legal dispute for the benefit of the trier of fact but not shared with opposing counsel or the opposing party, because the document is being reserved for future courtroom use if alternative dispute resolution is unsuccessful; and (3) The President's Daily Brief, the most highly classified top-level document in the Intelligence Community, “a daily summary of high-level, all-source information and analysis on national security issues produced for the president and key cabinet members and advisers” (https://www.intelligence.gov/publics-daily-brief/presidents-daily-brief), where it is exceptionally valuable for cleared U.S. intelligence professionals to know exactly what information was placed before the President of the United States at what precise day and time-including his real-time handwritten annotations, reactions, and instruction.

### SUMMARY OF THE INVENTION

This system solves four basic problems inherent in document control and provenance authentication, illustrated by the following descriptions and examples.

According to an aspect of the present invention, the disclosed subject matter may provide for version differentiation. In the creation of documents, particularly in text-dominant documents and in digital images changed by small subtle edits or by the application and use of artificial intelligence, multiple rapidly created versions may be perceptibly indistinguishable but materially different. When edits are made to documents, the sequence of edits and the person or entity making or supervising those edits are often key determinations to be made in investigations and legal proceedings.

In addition, according to an aspect of the present invention, the disclosed subject matter may provide for alteration detection. Documents, particularly those that are created in digital form, can be altered without the alteration necessarily being evident; two or more documents can be made to appear forensically alike with the same “digital DNA” but again, may be materially different or contain digital elements concealed or embedded within them in an effort to avoid digital detection.

Moreover, according to an aspect of the present invention, the disclosed subject matter may provide for proof of origin. Metadata is able to be manipulated to conceal precisely when, where, by whom, and in which system a document originated; however, the presently disclosed system provides a solution to ensure that original metadata is reflected without subsequent manipulation to a document.

Furthermore, according to an aspect of the present invention, the disclosed subject matter may provide for proof of existence. In the contexts of legal evidentiary documents and national security classified material, there is often a requirement for documents to be filed with controlling, reviewing, or judicial authorities along with proof of its existence so that they can be recorded for purposes of establishing claims, protection from false claims, third party dispute resolution, or establishing intelligence facts; in these instances, an opposing party or uncleared person can always be assured of the authoritative unaltered existence of a document, with no knowledge of its content, and without access to the original document. Content knowledge and access to the substance of the original document corresponding to the established proof of existence can thereafter subsequently be affirmed and provided by the system, but only at the discretion of, and with the permission of, the creator-originator or owner-controller of the original document.

The present disclosure of the invention addresses the shortcomings noted above, and the created Blockchain-Based System for Secure Document Provenance, Recording, and Authentication provides embodiments to solve problems that arise in conventional document management systems. The present invention accommodates document management systems and information management systems that are emerging, in development, or not yet created or in use, as well as addressing the delimited broader definition of “document” as anything able to be rendered in digital form, as described above in the background section.

A core aspect of the invention is the system process workflow in two parts: (1) taking original data of a physical or digital document and creating, through a conversion engine, its analogous registered document, which in an embodiment is at least initially stored and controlled by the creator-originator of the document; and (2) hashing, using a one-way cryptographic algorithm (a mathematical function used to transform data) applied to the registered document to generate a fixed-size hash value, which is a unique digital fingerprint corresponding to the original data, and create an entry on a blockchain (such as Ethereum) using the hash value that is unique to the registered document and inalterably ties to the original document.

When document authentication is required, demand is made later by any cooperating party requiring proof of provenance, a zero-knowledge proof corresponding to information entered on the blockchain and a decryption algorithm are used to authenticate the registered document. In this manner, zero-trust authentication of the original document can be assured.

Key features of the system process workflow according to an embodiment are:
Applicability to any original document in any form: The system is indifferent to document form or operating system (OS), including forms not yet created or in use.
Conversion engine: Documents are processed through a Software-as-a-Service (SaaS) conversion engine that renders the original document into the registered document.
Registered Document Control: Creator-originators at least initially own, control, and store registered documents, which tick-and-tie back to only one original document.
No Central Authority, Recordation, or Repository: Primary authorities are always with the owner-controller of the original document, and the registered document is always as secure or as secret as the original document. The owner-controller in a non-limiting embodiment is an entity (or plurality of entities) that owns and/or controls the original document and may be the same entity or a different entity from an originator of the document. The owner-controller, not the system provider, is also responsible in an embodiment of the invention for the security of the registered document.
Public Encryption Key: Asymmetric encryption yields the ciphertext that is hashed and becomes the entry on the blockchain that can authenticate the registered document.
Tolling: Cryptocurrency tolling may be a “pay-as-you-go” process at several places in the system process workflow.
Blockchain Anonymity: Absent a demand for authentication, the kernel substantiating the existence of the registered document remains as an indecipherable ciphertext on the blockchain.
Conditions and Controls: Strict conditions must be met to authenticate a document; importantly, the creator-originator or owner-controller must agree with and approve the authentication.

The clear benefits of the invention are the ability to authenticate documents easily and authoritatively; enhanced security; the immutability of document records; and vastly improved transparency in the tracking of document origin, etiology, history, and version differentiation.

Beyond these user-facing benefits, the presently disclosed subject matter provides specific technological improvements to the functioning of computers and to the functionality of blockchain-based data storage and retrieval. The disclosed combination of (i) a sandboxed content disarm and reconstruction (CDR) conversion engine that transforms heterogeneous input documents (URDOCs) into a uniform, reconstructed or re-rendered registered representation (the DEXURDOC), (ii) a cryptographic hashing module that generates a fixed-length (or variable-length) digital fingerprint (the KERN) of the reconstructed or re-rendered representation, (iii) registration of the KERN on a distributed blockchain ledger through a network consensus protocol, and (iv) a zero-trust zero-knowledge-proof-based verification pathway that authenticates a later-presented DEXURDOC against the on-chain KERN without exposing the underlying document content, cooperatively produces a concrete technical result not achievable by conventional centralized document management architectures.

The invention does not merely employ generic computer hardware as a tool to implement an otherwise-conventional document authentication workflow; rather, it transforms the manner in which the underlying computing and blockchain infrastructure operates, yielding technological improvements including: (a) elimination of single points of failure inherent in centralized repositories by distributing the authoritative proof-of-existence record across the nodes of a public blockchain; (b) tamper-evident recordation of document state at a fixed time, enforced by the collision-resistance of the cryptographic hash function and the immutability of the distributed ledger; (c) cryptographic binding among the URDOC, the DEXURDOC, and the on-chain KERN such that any undetected modification, intentional or otherwise, of any one of these artifacts causes authentication to fail; (d) neutralization of active-content and hidden-element attack vectors (such as macros, embedded scripts, and steganographic payloads) through the CDR reconstruction process, which cannot be achieved by mere storage or copying of the original file; and (e) zero-trust third-party verifiability of document provenance by means of a zero-knowledge proof, such that a verifier can confirm the correspondence between a presented document and the on-chain record without either the document content or the originator's private key being disclosed to the verifier or to the blockchain. Each of the foregoing is a technical improvement to the operation and performance of the underlying networked computing infrastructure and to the functionality of the blockchain itself, rather than an abstract idea implemented using a computer.

### BRIEF DESCRIPTION OF DRAWINGS

FIG. 1 illustrates an embodiment of a first system process workflow.

FIG. 2 illustrates an embodiment of a second system process workflow.

FIG. 3 illustrates an embodiment of a third system process workflow.

FIG. 4 illustrates an embodiment of a system architecture.

FIG. 5 illustrates an embodiment of nodes that may exist in the system.

### DETAILED DESCRIPTION

Embodiments of the disclosed Blockchain-Based System for Secure Document Provenance, Recording, and Authentication may have great utility in any information technology application where documents exist and require any measure of recordation, file control, or proof.

The system process workflow commences with an original document (referred to in this disclosure as an URDOC), that can exist in any initial format. An URDOC can be as simple as a page of word-processed text, a digital photograph, a PDF document, an e-mail, an e-mail header, a laser printed page, or a piece of paper with handwritten information; an URDOC can also be complex—an archival paper document, a block of source code, or a compiled program, for example. U.S. government classified documents, including publications or digital documents in special access programs, can also be URDOCs. In theory and practice, anything that can be expansively described as a “document” and that can be rendered digitally in some manner or form, can be an URDOC. However, most URDOCs to which the system will apply are either digital images, as created or as edited, or a word-processed or edited text-only document, with or without figures or hidden elements embedded.

According to an embodiment, to begin the process of blockchain provenance, the URDOC is “converted” to a “registered” document, which may be called a DEXURDOC. The conversion engine may be provided over a network using Software-as-a-Service (SaaS) architecture within the system.

In an embodiment, the SaaS document conversion engine performs a content disarm and reconstruction (CDR) function to create the DEXURDOC, while simultaneously generating a blockchain-verified provenance record, referred to as the KERN, which is registered on the blockchain for zero-trust tamper-evident document proof-of-integrity regarding the DEXURDOC.

Modern digital documents frequently contain executable components, metadata, embedded objects, or hidden scripts that create cybersecurity risks and data leakage vulnerabilities. Any exchange of documents across enterprise boundaries may face persistent threats including macro malware, steganographic payloads, hidden metadata exposure, and unauthorized document manipulation, more particularly in an artificial intelligence-driven environment.

Existing detection systems attempt to identify malicious code patterns, but fail to detect previously unknown and unknowable threats, as well as threats that have not yet been created.

Conventional CDR solutions do not provide immutable verification of document authenticity or chain-of-custody records. This system integrates secure document reconstruction (or re-rendering in a converted form) with blockchain-based verification that provides provable document provenance and tamper evidence of the DEXURDOC, which is directly tied to, and inalterably reflective of, the URDOC.

In an embodiment of the present disclosure, through the SaaS document conversion engine, the system provides a secure document authentication platform that is configured to:
Ingest or otherwise acquire URDOCs in one or more of various, infinitely variable digital formats;
Parse and analyze an internal file structure of each URDOC;
Recognize and structure for storage any active content and hidden elements, such as metadata, of each URDOC document;
Create an authoritative DEXURDOC for each URDOC that reconstructs, re-renders, or otherwise converts data originating in and organic to the URDOC, the DEXURDOC being directly tied to the URDOC and its content (both active content and hidden elements, such as metadata, carrier data, steganography data, or other embedded data) at a time of acquisition;
Generate a cryptographic record (a hash of the reconstructed, re-rendered, or otherwise converted DEXURDOC document) as the KERN;
Record or register the KERN hash inclusive of any originator-associated metadata, carrier data, steganography data, or other embedded data of any kind or type (without limitation collectively referred to herein as “metadata”) on the blockchain ledger; and
Enable zero-trust third-party independent verification of document authenticity.

The system's SaaS conversion engine accepts uploaded files, parses their internal structure, and reconstructs or re-renders the DEXURDOC version of the document. Rather than copying the original file directly, the system renders visible content into a new “document container,” analogous to “sealing” the DEXURDOC in a closed package as a form of secure depository.

The system performs a multi-stage Content Disarm and Reconstruction (CDR) workflow that creates the DEXURDOC:
File Ingestion. URDOC is uploaded through a secure interface and processed in a sandbox environment.
URDOC Structure Parsing. The internal structure of the file is analyzed including text layers, macros, metadata, scripts, and embedded objects.
Identification and Cataloguing. Components such as macros, executable content, and external links of the URDOC are identified and catalogued.
Rendering Layer. The URDOC document is rendered onto a secure canvas.
Reconstruction or re-rendering of a new document container, the DEXURDOC, is generated from the identified and catalogued components of the URDOC.
Security Hardening. Optional protections include additional access control policies.

According to an embodiment, the representative system architecture includes:
User Upload Interface;
Secure Gateway;
Sandbox Processing Environment;
File Parser DEXURDOC Creation Engine;
Content Disarm Engine;
Rendering Engine;
Document Reconstruction Engine;
Security Layer;
KERN Creation Layer;
Blockchain Verification Module; and
KERN Distribution Interface.

The KERN hash value, date-timestamp, and document identifier are written to the blockchain ledger. This ledger entry establishes an immutable record of a document that existed in a specific form at a specific time.

By combining secure document rendering into the DEXURDOC with cryptographic fingerprinting and distributed ledger records of the KERN, the system enables trusted digital documents suitable for all legal, investigative, regulatory, and intelligence environments.

In an embodiment, the conversion engine methodology includes the following features:
Preservation of URDOC content including visual, graphic, or screen identity. The SaaS conversion creates a DEXURDOC in the image of the URDOC. The only functional difference between the URDOC and the DEXURDOC is that the DEXURDOC is now in a “re-rendered” form that can be hashed and subsequently recorded on the blockchain.
Software as a Service (SaaS) distribution. Web-based conversion is available, Web 3 infrastructure, and licensing are all methods and processes for the conversion software.
Use of conversion engine activates smart contract. The smart contract is the first building block of transparency and tamper-proofing of the system. Self-executing at the moment of conversion of the URDOC to a DEXURDOC, the smart contract is designed automatically to execute the terms of the authentication agreement and initialize the DEXURDOC as existing in the system.
In this context, a smart contract is a self-executing program whose code and state are stored on the blockchain and whose execution is performed automatically and deterministically by the nodes of the blockchain network when predetermined conditions are satisfied. On Ethereum, smart contracts are typically authored in a high-level programming language such as Solidity or Vyper, compiled into bytecode, and deployed to a published contract address on the Ethereum Virtual Machine (EVM); invocation of such a contract by a transaction causes every validator on the network to independently perform the same computation and reach consensus on the result, such that the outcome of the contract's execution is recorded immutably on the ledger. This property makes smart contracts well-suited for encoding the authentication-related conditions and controls of the disclosed system, because the logic governing KERN registration, authentication demand, creator-originator or owner-controller agreement to authenticate, and verification of conformance between a presented DEXURDOC and the on-chain KERN is executed identically and verifiably by every participating node, without reliance on any centralized trusted party. In alternative embodiments, analogous programmable on-chain logic may be implemented on other smart-contract-capable blockchains (e.g., via Chaincode on Hyperledger Fabric, or via comparable constructs on Solana, Avalanche, or Polygon), and the disclosed system is not limited to any particular smart-contract platform.
Integral cryptocurrency tolling architecture. Upon use of the SaaS conversion engine, wherever such module resides, to create any DEXURDOC, a small cryptocurrency toll is charged to the user (creator-originator and/or owner-controller) of the DEXURDOC. A robust architecture may be created throughout various layers or nodes of the system to extract cryptocurrency tolls for services performed by or within the system.
“Pay as you go” collection of cryptocurrency toll. Tolling is charged for system-based services actually used; use of the system does not require any ongoing charges or bulk charges. Cryptocurrency tolls may be charged for online SaaS registration and subscription, or for remote application mounting on desktop workstations, enterprise servers, or mobile devices.
Seamless integration across dissimilar operating systems. The enterprise software architecture is indifferent as to operating system, programming language, foreign language, or information technology system.
Conversion engine creates a DEXURDOC using the URDOC. After the conversion re-rendering through the SaaS engine, the resultant document is a DEXURDOC. The re-rendered DEXURDOC ticks-and-ties back to the URDOC. In accounting theory, “ticks-and-ties” refers to the conventional process of verifying and reconciling numbers within and between financial statements and financially related supporting schedules, to ensure accuracy and consistency. A “tick” means that an accounting entry has been reviewed and verified for accuracy. A “tie” extends the process to make sure that related entries match across related documents. The accounting expression “tick-and-tie” is adopted for use in this system to demonstrate the technical verification of the relationship between URDOC and DEXURDOC.
DEXURDOC is the system's primary document for registration. Because URDOCs can take so many forms—any form—a uniform DEXURDOC is necessary before encryption and blockchain recordation. The DEXURDOC is the system's fundamental core document and is always in the possession and control of the URDOC's owner-controller as creator-originator of the DEXURDOC. In an embodiment, the creator-originator or owner-controller alone stores and secures the DEXURDOC.
Any URDOC edit, revision, or alteration requires a new DEXURDOC. One DEXURDOC only ever ticks-and-ties back to one URDOC. Any time a document is edited or modified in any way, it becomes a new URDOC and the conversion process must be performed again. This requirement can be automated or adapted to artificial intelligence control. An URDOC can be used to create any number of DEXURDOCs, but each DEXURDOC only reconciles to a single URDOC. Examples of a document being edited or modified, and thus requiring the creation of a new DEXURDOC, include: (1) a collaborator editing and using “Track Changes” then saving the next version of a word-processed legal brief; (2) handwritten notes in the right margin of a printed Top Secret Codeword controlled paper document; or (3) the electronic signature of a quality assurance engineer on a manufacturing process control tablet-displayed document.
In an embodiment, only the end user keeps, stores, or shares DEXURDOCs. The “creator-originator” or “owner-controller” of the URDOC who creates the DEXURDOC keeps the DEXURDOC in his, her, or its own data storage location. Once created through the SaaS conversion “re-rendering” process, the DEXURDOC in an embodiment never leaves the ownership, control, or security authorities of its creator-originator, although it is possible that the DEXURDOC may be transferred using the system to an owner-controller that is a different entity from the creator-originator. A security vulnerability may exist inherently outside this system when the owner stores the DEXURDOC. A DEXURDOC is only as secure as the degree of security that its owner provides for it. However, if a DEXURDOC is ever corrupted, altered, or compromised, the system will no longer recognize it as a conformal DEXURDOC, meaning it no longer has a form that authenticates back to the URDOC.
DEXURDOC, once created, cannot be altered. If a DEXURDOC is altered, it no longer authenticates to the original URDOC and must be reprocessed and re-rendered through the conversion engine to create a new, different DEXURDOC. The system provides iterative, consistent version control by the production of new DEXURDOCs.
Viewing or accessing DEXURDOC may require a cryptocurrency toll. Each action accessing a DEXURDOC for any purpose may be tolled in a practical application of the system, with the accessing user through the system's document accounting controls; the content of the DEXURDOC is never exposed to the system, but the act of accessing is recorded and tolled.

All operations re-rendering a DEXURDOC occur seamlessly and simultaneously with operations of the SaaS conversion engine. The same system may be configured to charge the cryptocurrency tolling. The presently disclosed system can create its own cryptocurrency token for tolling, or to toll using existing tokens. There is no central authority, recordation, or control of any DEXURDOC.

Additional steps in the system process may be required before the existence and provenance of the generated DEXURDOC is able to be recorded on a blockchain (such as Ethereum). These steps may require cryptocurrency tolling.

Each operator of the system may be required to have a pair of cryptographic keys, public and private keys to be used in asymmetric encryption, that are compatible with the system and able to encrypt a DEXURDOC as a KERN with at least one of the public keys or the private key to create the hash value.

Once a DEXURDOC is generated by the SaaS conversion engine re-rendering process, a separate process is initiated immediately, may be performed as a parallel process, and may require cryptocurrency tolling. Like the creation of the DEXURDOC, this process may occur seamlessly and automatically and is able to be instituted by artificial intelligence programs.

The new process is one where, through at least one of a public key or a private key encryption hash and the application of a different protocol, a KERN is created in an embodiment. Hashing and the creation of a KERN may require cryptocurrency tolling.

In various embodiments, the cryptographic hash function employed by the system to generate the KERN may be, by way of non-limiting example, SHA-256 (the 256-bit variant of the Secure Hash Algorithm 2 family, widely used in Bitcoin and in numerous other blockchain systems), Keccak-256 (the hash function natively employed by the Ethereum blockchain and forming the basis of the SHA-3 standard), BLAKE2, BLAKE3, or any other cryptographically secure hash function exhibiting the preimage resistance, second-preimage resistance, and collision resistance properties required for tamper-evident ledger registration. The particular hash function selected may be dictated by the blockchain on which the KERN is registered—for example, registration on the Ethereum blockchain in a representative embodiment employs Keccak-256, while registration on a Bitcoin-derived chain employs SHA-256—or may be selected independently of the chain-native hash where a wrapper protocol or smart contract accepts an arbitrary-length digest as input. Because a cryptographically secure hash function is deterministic, accepts input of arbitrary length, and produces a fixed-length output (for SHA-256 and Keccak- 256, a 256-bit digest), the KERN serves as a compact, collision-resistant commitment to the entire DEXURDOC that can be published on the blockchain and subsequently verified against a presented DEXURDOC by recomputing the hash and comparing the result, byte-for-byte, to the on-chain value.

There are three major features of the hashing and KERN creation protocol: (1) a public encryption key, (2) creator-originator or owner-controller control, and (3) the KERN is designed to “cross the public wall,” meaning that while its creation is at least initially controlled by the creator-originator, once a KERN is in existence, it is visible to anyone.

A KERN is simply a hash on the blockchain. It is unidentifiable to anyone except to the originator/controller of its associated DEXURDOC. Features of the KERN include the following:
A “genome map” of its associated DEXURDOC and URDOC. The KERN, once hashed and created, is a mathematical and cryptographic record of the DEXURDOC and the corresponding URDOC that are associated with the KERN.
KERN unique to one DEXURDOC only. Each KERN, a matchless random-presenting series or sequence of alphanumeric symbols, is unique to one DEXURDOC, which in turn tics-and-ties to only one URDOC. In the reverse direction, an URDOC can be used to create any number of DEXURDOCs, making available any number of avenues for authentication.
Permanence, absolute data integrity and immutability. A KERN, once created, is immutable and unchanging due to its registration on the blockchain. Any alteration to a KERN results in its decoupling from its linked DEXURDOC; authentication would fail.
Fixes the existence and time of creation of the DEXURDOC. In an embodiment of the system, due to the establishment of a KERN outside the “public wall,” the KERN can prove origin, etiology, date-time authentication, and provenance of the DEXURDOC. When related variant DEXURDOCs are all authenticated, transparent immutable proof of version may be enabled.
The KERN is public on a blockchain (such as Ethereum). Each KERN is published on the blockchain at the moment of its creation/establishment. The system may be configured to allow for KERN creation on blockchains other than Ethereum in contemplated embodiments of the system.
Only a creator-originator and/or an owner-controller of an original document can associate a DEXURDOC and the URDOC of the original document. While the KERN is public on the blockchain, there exists no capability or possibility for any observer of this public record, or for any bad actor, to know where that KERN associates. The only party able to “unlock” the URDOC (via its association with the DEXURDOC) is the creator-originator and/or owner-controller who controls the DEXURDOC, which is “unlocked” using the KERN through the public key decryption protocol.
Once more, a security vulnerability outside the system may exist. The creator-originator at least initially controls and owns the DEXURDOC in an embodiment of the invention. Compromise or alteration of the DEXURDOC, re-encryption by bad actors, or intrusion and/or destruction of the originator/controller's storage system for DEXURDOCs, breaks the authorities binding KERN, DEXURDOC, and URDOC. The disclosed Blockchain-Based System for Secure Document Provenance, Recording, and Authentication is designed to be entirely failsafe and secure. However, its human users and products are only as secure as the systems they employ outside of and apart from this system's embodiments.
Zero-trust verifiability of DEXURDOC. Once a KERN is hashed, created, and entered or otherwise published on the blockchain, its associated DEXURDOC is inalterably locked to the public KERN. The system provides for zero-trust verifiability of the DEXURDOC in the re-rendering of the URDOC, with the KERN providing authentication of the provenance of the DEXURDOC.

As described above, blockchain-enabled provenance proof of a DEXURDOC may only be performed with the involvement of the creator-originator/owner-controller having prior knowledge of the association between the KERN and the DEXURDOC used to create the hash value represented by the KERN. If the creator-originator/owner-controller of the URDOC loses or misplaces the information about the association between the KERN and the DEXURDOC, authentication may not be possible without recovering that information. Concurrently, if a bad actor gains access to this information, all he will have is knowledge of a relationship between the KERN and the DEXURDOC; he will not have gained knowledge of the content of the URDOC, which remains secure—as secure as the creator-originator/owner-controller provides for that content.

Verification of the KERN-associated DEXURDOC and URDOC may require cryptocurrency tolling in various embodiments and stages of the disclosed system.

Document authentication is the final stage of the system process workflow. Authentication commences with an “authentication demand” by an intentional receiver, and an agreement to accept the authentication demand on the part of the creator-originator/owner-controller.

Requirements precedent to the authentication process are that the receiver must know of the existence of a KERNed document to demand it, and the creator-originator/owner-controller must be agreeable to provide the authentication.

There are six conditions and controls that are steps in the authentication process. The steps take place in the conversion engine of the SaaS portal, app, or program. At least some of the steps may require cryptocurrency tolling. Appropriately, authentication may require more tolling than creation of a record.
The DEXURDOC, owned and stored by its creator-originator/owner-controller, is tied to KERN. The proper maintenance of the DEXURDOC is, and has been since KERN creation, the responsibility of the creator-originator/owner-controller.
Receiver requests DEXURDOC authentication via the blockchain. Authentication demand is public, on blockchain, establishing the existence and timing of the demand. Cryptocurrency tolling may be charged at this stage in accordance with the received request for authentication.
Creator-originator/owner-controller agrees to authentication on the blockchain. Handshake agreement is likewise public, establishing the existence and timing of the creator-originator/owner-controller agreement to authenticate. Cryptocurrency tolling may be charged at this stage.
The DEXURDOC is unaltered and still conforms to the original KERN hash. If the DEXURDOC is compromised, either deliberately or by owner negligence, authentication will fail.
Creator-originator/owner-controller makes DEXURDOC available to receiver. When the authentication demander receiver and the creator-originator/owner-controller agree to document provision and exposure, the KERN-conformal DEXURDOC is made available to the receiver; upon reversal of a re-rendering conversion process, the DEXURDOC is visually or auditorily identical to the URDOC from which the DEXURDOC was created.
Receiver uses a zero-knowledge proof from the blockchain and a decryption algorithm to authenticate DEXURDOC. A decryption software process including a zero-knowledge proof concludes the authentication of the DEXURDOC to the satisfaction of the system and the receiver.

A zero-knowledge proof, as employed in the presently disclosed system, includes a cryptographic protocol by which a first party (the prover) is able to demonstrate to a second party (the verifier) that a given statement is true—for example, that the prover possesses a DEXURDOC whose cryptographic hash matches a specific KERN previously published on the blockchain—without revealing any information beyond the truth of that statement. Suitable zero-knowledge protocols include, without limitation, zk-SNARKs (zero-knowledge succinct non-interactive arguments of knowledge), zk-STARKs (zero-knowledge scalable transparent arguments of knowledge), Bulletproofs, and PLONK-family constructions.

In a representative embodiment, a succinct proof is generated off-chain by the creator-originator/owner-controller from the DEXURDOC and a proving key, and is subsequently verified either on-chain (by a verifier smart contract) or off-chain (by the receiver, using a verification key derived from the KERN registration), with the verification procedure requiring computational effort that is polylogarithmic or constant in the size of the DEXURDOC and thus computationally tractable even for large documents. The use of a zero-knowledge proof in the authentication step enables the receiver to verify, with cryptographic certainty, that a presented DEXURDOC corresponds to the on-chain KERN without the content of the DEXURDOC, the content of the URDOC, or the creator-originator's private key being disclosed to the receiver, to the blockchain, or to any other third party, thereby preserving the confidentiality of the creator-originator's or owner-controller's document while still providing zero-trust third-party verifiability.

### Components and Functionality of the System Architecture

### (1) User Interface

According to an embodiment, there are three available user interface modalities of the system:
Desktop or mobile device access of online system portals. Most documents that will require authentication by and through this system—principally presumed to be business documents, national security classified documents, or legal documents—will originate as URDOCS in office spaces. Creator-originator/owner-controllers in these environments will use a portal to access the system.
Installed desktop/laptop application or mobile device app linked to system portals. With undergirding secure web connection, the keyboard-and-screen accessible application or mobile device app provide a user interface that performs the same tasks as the portals.
Secure client-unique custom integrated application user interface. For specialized utility where large numbers of like-kind documents will be processed, the system can be customized for end user integration with specialized systems. For example, documents filed on the dockets of the U.S. federal court system, quality assurance documents requiring conformity to ISO 9001 globally recognized standards for quality management systems, or classified documents in the Intelligence Community.

### (2) Software Components

In an embodiment, the conversion engine by which an URDOC is rendered into a DEXURDOC is a Software-as-a-Service (SaaS) offering, which may be made available through a license. The Blockchain-Based System for Secure Document Provenance, Recording, and Authentication is the overall system by which documents are processed and authenticated. The integrated software elements presently disclosed are considered component parts of the system.

According to an embodiment, the SaaS software, accessible through the three types of user interfaces, may have the following component features:
Software source code is accessible over a network and non-downloadable in nature.
The DEXURDOC generation engine creates the DEXURDOC in a form able to be hashed by the system and properly stored, unaltered and unalterable, by the creator-originator/owner-controller.
KERN hashing includes cryptographic hashing of the KERN and posting to the Ethereum Blockchain.
The authentication protocol may include a zero-knowledge proof protocol authenticating the KERN back to its DEXURDOC, including the authentication demand, the agreement by the creator-originator/owner-controller to provide authentication, and the process of authentication proof.
Cryptocurrency tolling may be implemented for automatic tolling of system users at various stages during operation of the system. For the benefit of intermittent users of the system, or for users without dedicated cryptocurrency accounts denominated in the correct cryptocurrency form, a credit card merchant account cryptocurrency purchase sub-system may permit real-time instantaneous purchase of the cryptocurrency required for the automatic tolling. Moreover, in an embodiment, the system may issue its own cryptocurrency and/or other form of coin to facilitate the cryptocurrency tolling.

In a non-limiting embodiment of the invention, use of the system is not permitted without tolling the creator-originator and/or owner-controller, as well as the authentication demander.

Because the system may be configured to use cryptocurrency tolls, expenses to the system's users may not require either the creator-originator/owner-controller or the authentication demanders to share their private identities with the system or with each other. In an embodiment, if a cryptocurrency wallet holds an insufficient amount of coin to fulfill the toll for the cost of a transaction, or if the credit card merchant account cryptocurrency purchase sub-system is not activated by the user, the software may not perform the transaction, or may automatically purchase a sufficient amount of cryptocurrency to perform the transaction, as described above.

### (3) Nodes Participating in the Network

The system is fully enabled with Web 3 and any ensuing advances, leveraging evolving blockchain technology to provide the technical authorities for the user-controlled registries of documents held by the creator-originator/owner-controllers; substantiate the documents by the application of public key cryptography; and register them each by a unique hash on blockchain.

Through this use of specialized information technology, there is no reliance on centralized databases, and more control of users over their own documents.

These nodes exist in a non-limiting exemplary embodiment of the system:
User node. Acquires and holds URDOCs and associated DEXURDOCs in local storage.
Interface node. Portal or app interface with the system's Web 3 enabled software engine for the creation of DEXURDOCs and KERNS, and for interacting with the authentication process.
Software node. SaaS module implemented as network-accessible node in the system, where URDOCS are converted to DEXURDOCs and DEXURDOCs are hashed to create KERNs.
Blockchain interface node. Where hashed KERNs are posted to the blockchain for registration, with a record of the registration being publicly available upon achieving network consensus or other blockchain-specific protocol for registration of a block of data including the KERN.

### (4) The Role of Blockchain Technology in the System

Blockchain technology is central to an embodiment of the disclosed Blockchain-Based System for Secure Document Provenance, Recording, and Authentication.

A blockchain, such as Ethereum referenced herein as an illustrative example, is a distributed, append-only ledger maintained across a network of independent computing nodes rather than by any single central authority. Data recorded on the blockchain is organized into discrete units called blocks, each block containing a batch of transactions or other data records together with a cryptographic hash value computed from the contents of the immediately preceding block. Because each block references the hash of its predecessor, the blocks are linked sequentially to form a chronologically ordered chain, and any attempt to alter a previously recorded block would change that block's hash and thereby invalidate the hash references stored in every subsequent block. This structural dependency gives the blockchain its characteristic immutability. Once a block has been written to the chain and confirmed by the network, its contents cannot be retroactively modified without detection by any participating node.

New blocks are added to the blockchain through a consensus protocol executed by the participating nodes. In the case of Ethereum, prospective transactions are broadcast to the network and collected into a candidate block by a validator node. Under Ethereum's proof-of-stake consensus mechanism, a validator is pseudo-randomly selected from a pool of participants who have staked a quantity of the native cryptocurrency (ether) as collateral, and the selected validator proposes the next block. Other validators in the network then attest to the validity of the proposed block, and once a sufficient threshold of attestations is reached, the block is finalized and appended to the chain, becoming part of the permanent, publicly visible record maintained in common by the participating nodes. The validator that successfully proposes a finalized block receives a reward in ether, which incentivizes honest participation in the consensus protocol.

Hash values are central to the operation of a blockchain. A cryptographic hash function is a one-way mathematical function that accepts an input of arbitrary length and typically produces a fixed-length output (variable-length outputs are also contemplated within the scope of the disclosure), referred to as the hash value or digest. The hash value or digest is, for practical purposes, unique to the input. Such hash functions are deterministic, such that the same input always produces the same output, and are collision-resistant, such that it is computationally infeasible to find two distinct inputs that produce the same output; even a single-bit change in the input yields a drastically different output.

These properties make hash values useful for at least two purposes in the blockchain context: first, for linking each block to its predecessor as described above, such that the integrity of the entire chain can be independently verified by any node; and second, for providing a compact, tamper-evident fingerprint of underlying off-chain data—such as, in the presently disclosed system, a DEXURDOC—that can be committed to the blockchain without the underlying data itself being exposed on the ledger. The hash value thus serves both as the structural mechanism by which blocks are chained together and as the representational primitive by which information about off-chain data may be committed to the ledger in a verifiable manner.

In an embodiment, the blockchain may be employed in the system in these five roles:
Posting the KERN hash. At the moment of its creation, the KERN is entered on the blockchain.
DEXURDOC and KERN creation registration. Without exposing the content, origin, or etiology of the DEXURDOC, the entry of the KERN on the blockchain permanently, transparently, accountably, and inalterably establishes the creation and provenance of the DEXURDOC document.
Authentication demand and agreement. The blockchain is employed to establish the authentication demand and, a corresponding agreement to proceed with authentication, with the same transparency and inalterability of the DEXURDOC and KERN.
Authentication pathway. The authentication protocol is registered on the blockchain.
Tolling accounting and accountability. When actions requiring tolling are performed in and by the system and costs are appropriately accounted, blockchain registration—encrypted or decrypted—provides a simple audit chain.

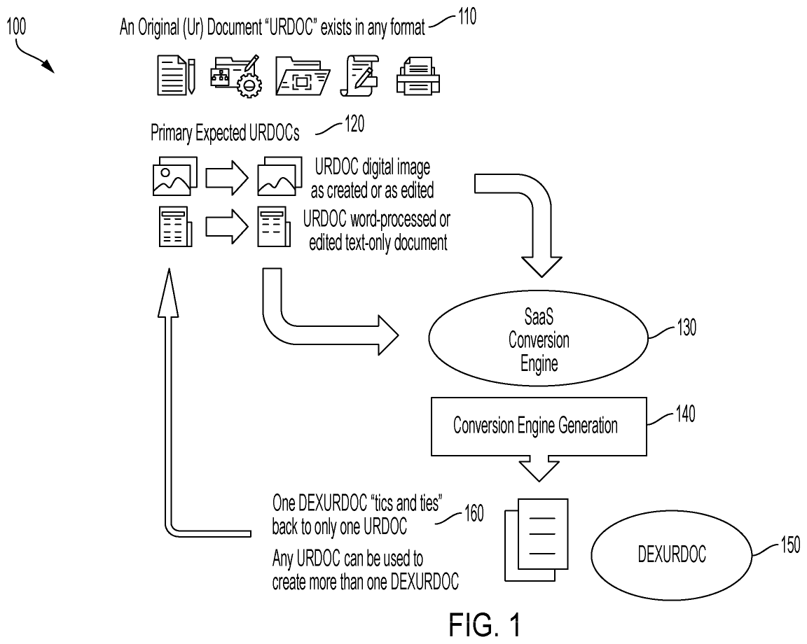

FIG. 1 illustrates a system process workflow 100 for creation of a DEXURDOC. The system process workflow 100 includes acquiring an original document (URDOC) at step 110, with such file acquisition or ingestion occurring by a creator-originator/owner-controller uploading the URDOC at step 120 into the system using a secure interface so that the URDOC may be processed in a sandbox environment. The system process workflow 100 further includes parsing an internal structure of the URDOC at step 130, such as by analysis of text layers, macros, metadata, scripts, and/or embedded objects of the URDOC, and then converting the URDOC to a registered document (DEXURDOC) at step 140 that preserves at least one of a visual, graphic, auditory, or screen identity of the URDOC from which the DEXURDOC is converted.

Components of the URDOC such as macros, executable content, and external links of the URDOC are identified and catalogued through the analysis, and the URDOC document may be rendered onto a secure canvas in an embodiment. The conversion of the URDOC to the DEXURDOC at step 140 may include reconstruction or re-rendering of a protective layer, the DEXURDOC, which is generated from the identified and catalogued components of the URDOC, along with results of the analysis of the internal file structure of the URDOC.

The system process workflow 100 further includes storing the DEXURDOC locally with a creator-originator and/or owner-controller of the URDOC and DEXURDOC at step 150. Upon request, authentication processing may take place at step 160 to confirm correspondence between the DEXURDOC and the URDOC from which the DEXURDOC was converted.

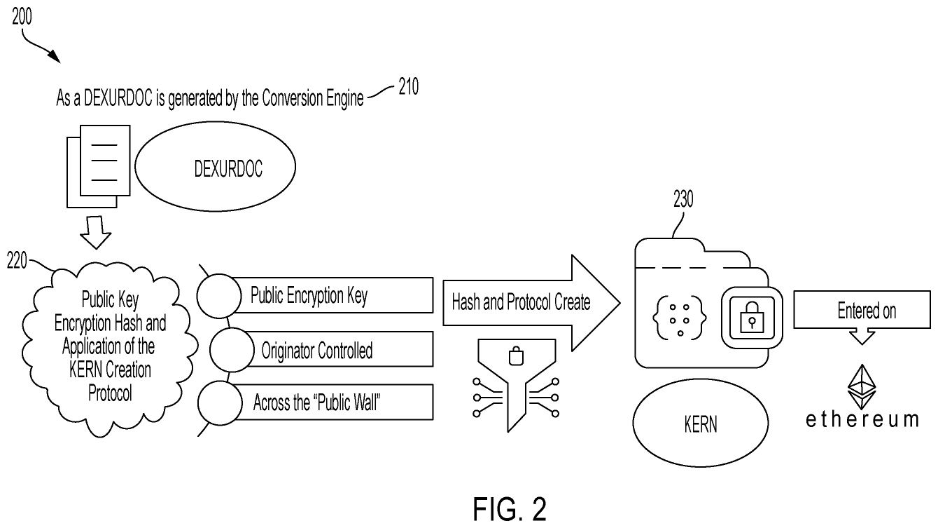

FIG. 2 illustrates a system process workflow 200 for creation of a KERN. The system process workflow 200 includes, at step 210, acquiring the DEXURDOC generated by the system process workflow 100 described above. Acquisition of the DEXURDOC may be substantially simultaneous with its generation through the SaaS conversion from the URDOC. The acquired DEXURDOC is used to create the KERN at step 220 by public key encryption and hashing of the DEXURDOC. Once the KERN is created, it is entered, recorded, registered, or otherwise made publicly available as data in a block of a blockchain (e.g., Ethereum in a non-limiting embodiment of the disclosed invention) at step 230. Reference to Ethereum in FIG. 2 is an illustrative example only, and other blockchains with various decentralized blockchain technologies may be used.

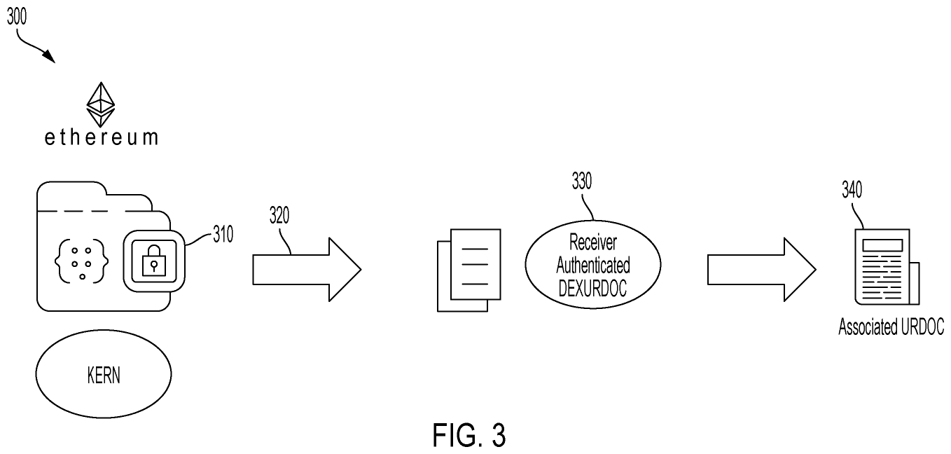

FIG. 3 illustrates a system process workflow 300 for document authentication. The system process workflow 300 includes receiving at step 310 an authentication demand or other request for authentication of a document, the demand or request being received via the blockchain. In an embodiment, the system process workflow 300 includes requesting a creator-originator/owner-controller at step 320 to agree to authentication of a DEXURDOC. Upon agreement of the creator-originator/owner-controller, the system process workflow 300 of an embodiment further includes authenticating the DEXURDOC at step 330 by determining whether it conforms to the KERN entered on the blockchain including the hashed value of the DEXURDOC, and providing the DEXURDOC to a receiver requesting authentication. The receiver may then determine information regarding the associated URDOC at step 340, using the received DEXURDOC. Reference to Ethereum in FIG. 3 is an illustrative example only, and other blockchains with various decentralized blockchain technologies may be used.

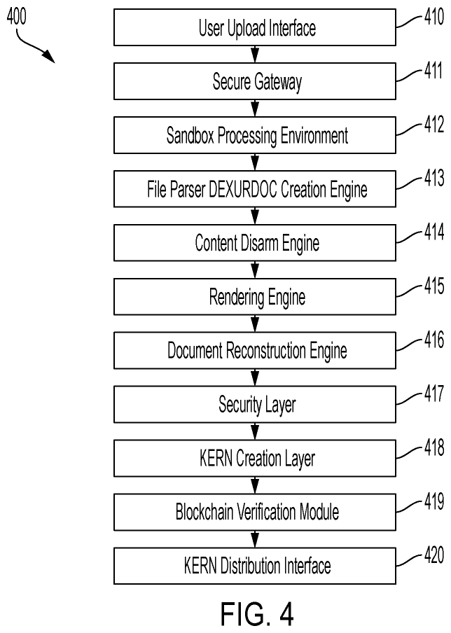

FIG. 4 illustrates an embodiment of a system architecture 400. The system architecture 400 includes: User Upload Interface 410; Secure Gateway 411; Sandbox Processing Environment 412; File Parser DEXURDOC Creation Engine 413; Content Disarm Engine 414; Rendering Engine 415; Document Reconstruction Engine 416; Security Layer 417; KERN Creation Layer 418; Blockchain Verification Module 419; and KERN Distribution Interface 420.

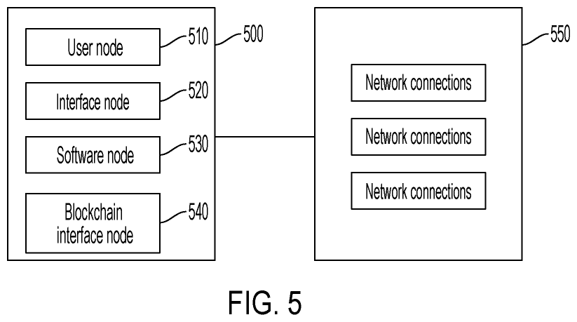

FIG. 5 illustrates an example of a system 500 including nodes used to execute system processing related to the processes disclosed above. Nodes of the system may be configured to communicate via a network. Each node of the system may be implemented via a processor or computer including circuitry and other electronic components according to an embodiment and may include a CPU or a GPU. The computer may be configured to execute the program stored on the non-transitory computer-readable storage medium.

In an embodiment, nodes of the system 500 may include a user node 510, an interface node 520, a software node 530, and a blockchain interface node 540. Nodes of the system 500 may be configured to communicate via one or more network connections 550.

The operations performed by the disclosed system—including, without limitation, content disarm and reconstruction (CDR) of heterogeneous digital file structures of URDOCs within a sandboxed processing environment, cryptographic hashing of each reconstructed or re-rendered DEXURDOC using a collision-resistant one-way mathematical function to produce a fixed-length hash value or digest (the KERN), public-key and/or private-key asymmetric encryption of document-associated data, registration of the resulting hash value on a distributed blockchain ledger through a consensus protocol executed across a network of independent computing nodes, programmatic execution of smart-contract logic by the nodes of that network, and zero-knowledge-proof-based verification of a presented DEXURDOC against the on-chain KERN—cannot practically be performed in the human mind, by human observation, or with pen and paper.

These operations are inherently computational and cryptographic in nature, require the coordinated execution of deterministic mathematical functions across networked computing devices, and depend for their security and correctness on properties (e.g., the collision resistance of the hash function, the computational infeasibility of forging a valid zero-knowledge proof, the consensus-based finality of a blockchain block) that have no meaningful analogue in manual human processing. A single invocation of a cryptographic hash function such as, by way of example, SHA-256 or Keccak-256, over a document of even modest size requires the execution of many millions of bitwise and arithmetic operations on binary data, and the verification of a zero-knowledge proof requires the evaluation of algebraic constraints over large finite fields; neither is within the practical capability of a human performing the operations mentally or with pen and paper.

The disclosed subject matter is therefore necessarily, inextricably rooted in computer and network technology and is directed to a problem—the tamper-evident authentication of documents across a distributed, untrusted network of participants—that arises specifically in the realm of networked digital information systems and that did not exist prior to the advent of such systems. The disclosed circuitry, sandbox environment, conversion engine, hashing module, blockchain interface, and associated components are not mere generic computing recitations deployed to implement a pre-existing human activity, but rather are arranged in a specific configuration that, taken as a whole, provides a concrete improvement to the functioning of the computing infrastructure and to the functionality of the blockchain itself as compared to conventional existing and theorized centralized document management systems.

Embodiments of the present technology are not limited to the above-described embodiment(s), and various modifications can be made without departing from the scope of the present technology. Note that the effects described in the present description are merely explanatory or illustrative and are not limitative. The effects of the present technology are not limited to those described above, and the present technology may have effects other than or in addition to those described in the present description.

The present technology can also have the configurations as follows.
(1)

An information processing system including:
circuitry configured to
   acquire information regarding original data of a document,
   convert the information regarding the original data of the document into converted information including a reconstructed rendering of the document indicating the information regarding the original data of the document in a reconstructed form,
   create a hash value by hashing the converted information including the reconstructed rendering of the document, and
   enter, on a blockchain, the hash value created using the converted information including the reconstructed rendering of the document.
(2)

The information processing system according to (1),
wherein the circuitry is further configured to perform authentication processing to determine correspondence between the hash value and the converted information used to create the hash value.
(3)

The information processing system according to (1) or (2),
wherein the circuitry performs the authentication processing based on a request submitted on the blockchain.
(4)

The information processing system according to any of (1) to (3),
wherein the circuitry performs the authentication processing upon agreement to perform the authentication by a user controlling the converted information.
(5)

The information processing system according to any of (1) to (4),
wherein the agreement to perform the authentication is entered on the blockchain.
(6)

The information processing system according to any of (1) to (5),
wherein the hash value is entered on the blockchain along with information indicating a time when the hash value is entered on the blockchain.
(7)

The information processing system according to any of (1) to (6),
wherein the hash value is entered on the blockchain along with information indicating a document identifier of the converted information including the reconstructed rendering of the document.
(8)

The information processing system according to any of (1) to (7),
wherein the document is a digital image file, and
wherein the original data of the document includes content data and metadata.
(9)

The information processing system according to any of (1) to (8),
wherein the metadata indicates a time when the document is created.
(10)

The information processing system according to any of (1) to (9),
wherein the metadata indicates a location where the document is stored.
(11)

The information processing system according to any of (1) to (10),
wherein the metadata indicates a sequence of revisions to the content data of the document.
(12)

The information processing system according to any of (1) to (11),
wherein the converted information indicates the content data and the metadata of the original data in the reconstructed form.
(13)

The information processing system according to any of (1) to (12),
wherein the hash value is created by hashing the converted information using at least one of a public encryption key or a private encryption key.
(14)

The information processing system according to any of (1) to (13),
wherein, upon receiving an authentication demand, the circuitry is further configured to perform a parallel reversing process to authenticate the original data of the document.
(15)

The information processing system according to any of (1) to (14),
wherein the parallel reversing process includes
   determining correspondence between the hash value and the converted information used to create the hash value, and
   decrypting the converted information when the hash value is determined to correspond to the converted information.
(16)

The information processing system according to any of (1) to (15),
wherein the parallel reversing process further includes verification of a zero-knowledge proof corresponding to the hash value entered on the blockchain.
(17)

The information processing system according to any of (1) to (16),
wherein the circuitry converts the information regarding the original data of the document into the converted information by using a content disarm and reconstruction function applied to the information regarding the original data of the document.
(18)

The information processing system according to any of (1) to (17),
wherein the circuitry is further configured to
   parse an internal structure of the original data of the document, and
   identify and catalogue components of the document.
(19)

The information processing system according to any of (1) to (18),
wherein the circuitry parses the internal structure by analyzing text layers, macros, metadata, scripts, and embedded objects of the original data of the document, and wherein components of the document include macros, executable content, and external links.
(20)

An information processing method, executed by at least one processor, the method including:
acquiring information regarding original data of a document;
converting the information regarding the original data of the document into converted information including a reconstructed rendering of the document indicating the information regarding the original data of the document in a reconstructed form;
creating a hash value by hashing the converted information including the reconstructed rendering of the document; and
entering, on a blockchain, the hash value created using the converted information including the reconstructed rendering of the document.
(21)

A non-transitory computer-readable storage medium having embodied thereon a program, which when executed by a computer causes the computer to execute a method, the method including:
acquiring information regarding original data of a document;
converting the information regarding the original data of the document into converted information including a reconstructed rendering of the document indicating the information regarding the original data of the document in a reconstructed form;
creating a hash value by hashing the converted information including the reconstructed rendering of the document; and
entering, on a blockchain, the hash value created using the converted information including the reconstructed rendering of the document.

1. An information processing system comprising:
circuitry configured to
acquire information regarding original data of a document,
convert the information regarding the original data of the document into converted information including a reconstructed rendering of the document indicating the information regarding the original data of the document in a reconstructed form,
create a hash value by hashing the converted information including the reconstructed rendering of the document, and
enter, on a blockchain, the hash value created using the converted information including the reconstructed rendering of the document.

2. The information processing system according to claim 1,
wherein the circuitry is further configured to perform authentication processing to determine correspondence between the hash value and the converted information used to create the hash value.

3. The information processing system according to claim 2,
wherein the circuitry performs the authentication processing based on a request submitted on the blockchain.

4. The information processing system according to claim 3,
wherein the circuitry performs the authentication processing upon agreement to perform the authentication by a user controlling the converted information.

5. The information processing system according to claim 4,
wherein the agreement to perform the authentication is entered on the blockchain.

6. The information processing system according to claim 1,
wherein the hash value is entered on the blockchain along with information indicating a time when the hash value is entered on the blockchain.

7. The information processing system according to claim 1,
wherein the hash value is entered on the blockchain along with information indicating a document identifier of the converted information including the reconstructed rendering of the document.

8. The information processing system according to claim 1,
wherein the document is a digital image file, and
wherein the original data of the document includes content data and metadata.

9. The information processing system according to claim 8,
wherein the metadata indicates a time when the document is created.

10. The information processing system according to claim 8,
wherein the metadata indicates a location where the document is stored.

11. The information processing system according to claim 8,
wherein the metadata indicates a sequence of revisions to the content data of the document.

12. The information processing system according to claim 8,
wherein the converted information indicates the content data and the metadata of the original data in the reconstructed form.

13. The information processing system according to claim 1,
wherein the hash value is created by hashing the converted information using at least one of a public encryption key or a private encryption key.

14. The information processing system according to claim 1,
wherein, upon receiving an authentication demand, the circuitry is further configured to perform a parallel reversing process to authenticate the original data of the document.

15. The information processing system according to claim 14,
wherein the parallel reversing process includes
determining correspondence between the hash value and the converted information used to create the hash value, and
decrypting the converted information when the hash value is determined to correspond to the converted information.

16. The information processing system according to claim 15,
wherein the parallel reversing process further includes verification of a zero-knowledge proof corresponding to the hash value entered on the blockchain.

17. The information processing system according to claim 1,
wherein the circuitry converts the information regarding the original data of the document into the converted information by using a content disarm and reconstruction function applied to the information regarding the original data of the document.

18. The information processing system according to claim 1,
wherein the circuitry is further configured to
parse an internal structure of the original data of the document, and
identify and catalogue components of the document.

19. The information processing system according to claim 1,
wherein the circuitry parses the internal structure by analyzing text layers, macros, metadata, scripts, and embedded objects of the original data of the document, and
wherein components of the document include macros, executable content, and external links.

20. An information processing method, executed by at least one processor, the method comprising:
acquiring information regarding original data of a document;
converting the information regarding the original data of the document into converted information including a reconstructed rendering of the document indicating the information regarding the original data of the document in a reconstructed form;
creating a hash value by hashing the converted information including the reconstructed rendering of the document; and
entering, on a blockchain, the hash value created using the converted information including the reconstructed rendering of the document.

21. A non-transitory computer-readable storage medium having embodied thereon a program, which when executed by a computer causes the computer to execute a method, the method comprising:
acquiring information regarding original data of a document;
converting the information regarding the original data of the document into converted information including a reconstructed rendering of the document indicating the information regarding the original data of the document in a reconstructed form;
creating a hash value by hashing the converted information including the reconstructed rendering of the document; and
entering, on a blockchain, the hash value created using the converted information including the reconstructed rendering of the document.
